(19) United States
(12) Patent Application Publication
(10) Pub. No.: US 2023/0383424 A1
(43) Pub. Date: Nov. 30, 2023

(54) Spacer Frame for Use in an Alkaline Electrolyzer System

(71) Applicant: Ticona LLC, Florence, KY (US)

(72) Inventors: Yuehua Yu, Cincinnati, OH (US); Pruthesh Vargantwar, Overland Park, KS (US)

(21) Appl. No.: 18/317,137

(22) Filed: May 15, 2023

Related U.S. Application Data
(60) Provisional application No. 63/345,924, filed on May 26, 2022.

(51) Int. Cl. C25B 9/63; C25B 1/04; C25B 9/23; C25B 9/77

(52) U.S. Cl. CPC C25B 9/63; C25B 9/77; C25B 9/23; C25B 1/04

(57) ABSTRACT

An alkaline electrolyzer system comprising an electrochemical cell in proximity to a spacer frame is provided. The spacer frame contains a polymer composition that includes a polymer matrix that contains at least one polyarylene sulfide.

### RELATED APPLICATION

The present application is based upon and claims priority to U.S. Provisional Patent Application Ser. No. 63/345,924, having a filing date of May 26, 2022, which is incorporated herein by reference.

### BACKGROUND OF THE INVENTION

Alkaline electrolyzers utilize electrical energy to drive a chemical reaction. The fuel, e.g., alkaline water, is supplied to the electrochemical cell and product, hydrogen and oxygen, is removed from the electrochemical cell. An alkaline electrolyzer system generally includes a stack of individual cells that are in electrical and fluid communication with one another. Each cell includes several components, electrodes, separators, etc., which are retained in a particular orientation with one another so as to allow for the necessary fluid flow and electrical communication. To maintain the desired orientations, spacers in the form of spacer plates or frames surrounding active components are utilized. Conventional spacers are formed from metals or certain polymers, primarily polyphenylsulfone materials. While such materials can be formed in the desired shapes for spacers, they are relatively difficult and costly to form into the high precision shapes necessary to meet desired specifications. Other materials have been examined, but desirable materials must also be able to withstand the alkaline environment of the cell. As such, a need currently exists for spacers that can be more readily incorporated into an alkaline electrolyzer system.

### SUMMARY OF THE INVENTION

In accordance with one embodiment of the present invention, an alkaline electrolyzer system is disclosed that comprises an electrochemical cell in proximity to a spacer frame. The spacer frame contains a polymer composition that includes from about 40 wt. % to about 95 wt. % of a polymer matrix that contains at least one polyarylene sulfide and from about 5 wt. % to about 60 wt. % of at least one filler disposed within the polymer matrix.

In accordance with another embodiment of the present invention, an alkaline electrolyzer system is disclosed that comprises an electrochemical cell in proximity to a spacer frame that includes a curved wall defining a channel. The curved wall contains a polymer composition that includes a polymer matrix that contains at least on polyarylene sulfide.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a schematic view of one embodiment of an alkaline electrochemical reactor cell;

FIG. 2 is a schematic view of one embodiment of an alkaline electrochemical reactor cell;

FIG. 3 is a schematic view of one embodiment of an alkaline electrochemical reactor cell stack;

FIG. 4 is a schematic view of one embodiment of an alkaline electrochemical reactor cell; and

FIG. 5 is a schematic view of one embodiment of an alkaline electrolyzer system.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to an alkaline electrolyzer system that includes at least one alkaline electrolyzer spacer frame. The spacer frame may surround any component of an alkaline electrolyzer electrochemical cell or stack. For example and without limitation, the spacer frame may hold an electrode, separator, bipolar plate, current collector, or diffusion layer. The spacer frame may also simply provide spacing between other components of an alkaline electrolyzer electrochemical cell or stack. The spacer frame can contact a fluid being conveyed, such as the alkaline feed to or product from an alkaline electrolyzer, but need not directly contact the fluid, such as in the case of spacer plates.

Regardless, at least a portion of the spacer frame, if not the entire frame, contains a polymer composition that includes at least one polyarylene sulfide. In certain embodiments, the polymer composition can include a polymer matrix that can include at least one polyarylene sulfide in conjunction with one or more fillers disposed within the polymer matrix. For instance, the polymer matrix can include from about 40 wt. % to about 95 wt. % of at least one polyarylene sulfide and from about 5 wt. % to about 60 wt. % of at least one filler within the polymer matrix. The spacer frame can define a channel within the polymer composition, e.g., a channel for conveying a fluid to or from a component held by the spacer frame. By selectively controlling the particular nature of the polyarylene sulfide and the nature and concentration of other optional components within the composition, it has been discovered that the resulting composition can exhibit a combination of characteristics that are uniquely suited for a spacer frame. For example, the polymer composition may exhibit a relatively low melt viscosity, such as about 2,000 Pa-s or less, in some embodiments about 1,000 Pa-s or less, in some embodiments about 800 Pa-s or less, and in some embodiments, from about 50 to about 600 Pa-s, as determined by a capillary rheometer at a temperature of about 310° C. and shear rate of 1,200 seconds⁻1 in accordance with ISO 11443:2021.

Due to the relatively low melt viscosity, relatively high molecular weight polyarylene sulfides can also be employed with little difficulty. For example, such high molecular weight polyarylene sulfides may have a number average molecular weight of about 14,000 grams per mole (“g/mol”) or more, in some embodiments about 15,000 g/mol or more, and in some embodiments, from about 16,000 g/mol to about 60,000 g/mol, as well as weight average molecular weight of about 35,000 g/mol or more, in some embodiments about 50,000 g/mol or more, and in some embodiments, from about 60,000 g/mol to about 90,000 g/mol, as determined using gel permeation chromatography as described below. One benefit of using such high molecular weight polymers is that they generally have a low chlorine content. In this regard, the resulting polymer composition may have a low chlorine content, such as about 1,200 ppm or less, in some embodiments about 900 ppm or less, in some embodiments from 0 to about 800 ppm, and in some embodiments, from about 1 to about 500 ppm.

Despite having a low melt viscosity, the polymer composition may nevertheless maintain a high degree of impact strength, which can provide enhanced flexibility for the resulting spacer frame. For example, the polymer composition may exhibit a notched Charpy impact strength of about 20 kJ/m² or more, in some embodiments from about 40 to about 150 kJ/m², and in some embodiments, from about 55 to about 100 kJ/m², as determined at a temperature of 23° C. in accordance with ISO Test No. 179-1:2010. Beneficially, the polymer product has a high degree of thermal resistance and thus can exhibit good impact strength at both high and low temperatures. For example, the polymer product can exhibit a notched Charpy impact strength of about 10 kJ/m² or more, in some embodiments from about 20 to about 100 kJ/m², and in some embodiments, from about 30 to about 80 kJ/m², as determined at a temperature of −30° C. in accordance with ISO Test No. 179-1:2010.

The tensile and flexural mechanical properties may also be good. For example, the composition may exhibit a tensile strength of about 20 MPa or more, in some embodiments from about 25 to about 200 MPa, in some embodiments from about 30 to about 150 MPa, and in some embodiments, from about 35 to about 100 MPa; a tensile break strain of about 20% or more, in some embodiments about 25% or more, in some embodiments about 30% or more, and in some embodiments, from about 35% to about 100%; and/or a tensile modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The tensile properties may be determined in accordance with ISO Test No. 527:2019 at a temperature of 23° C. The composition may also exhibit a flexural strength of about 20 MPa or more, in some embodiments from about 25 to about 200 MPa, in some embodiments from about 30 to about 150 MPa, and in some embodiments, from about 35 to about 100 MPa and/or a flexural modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The flexural properties may be determined in accordance with ISO Test No. 178:2019 at a temperature of 23° C.

The polymer composition may also be generally resistant to permeation of fluids that may potentially be in contact with the spacer frame, such as hydrogen, oxygen, water, liquid electrolytes, liquid/gas mixtures, etc. For example, the polymer composition may have a hydrogen transmission rate of about 30 ml/m²*day or less, in some embodiments about 20 ml/m²*day or less, in some embodiments about 10 ml/m²*day or less, and in some embodiments, from about 0.1 to about 5 ml/m²*day, such as determined in accordance with ASTM D1434-82 (2015) (volumetric method) at a temperature of about 23° C. and pressure difference of 1 atmosphere. The polymer composition may likewise exhibit an oxygen transmission rate of about 30 ml/m²*day or less, in some embodiments about 20 ml/m²*day or less, in some embodiments about 10 ml/m²*day or less, and in some embodiments, from about 0.1 to about 5 ml/m²*day, such as determined in accordance with ASTM D1434-82 (2015) (volumetric method) at a temperature of about 23° C. and pressure difference of 1 atmosphere. The polymer composition may also be relatively pure in nature in that it contains a low level of extractable contaminants, such as about 2 mg/cm² or less, in some embodiments about 1.5 mg/cm² or less, and in some embodiments, about 0.5 mg/cm² or less of extractable compounds after contact with n-hexane (7 hours), acetone (7 hours), and/or deionized water (24 hours).

Due to the relatively low melt viscosity and the mechanical properties of the polymer composition, the composition is particularly well suited for spacer frames having a small dimensional tolerance. Such spacers, for example, generally contain a molded shape, e.g., a channel wall, with at least one micro-sized dimension (e.g., thickness, width, height, etc.) such as from about 1,000 micrometers or less, in some embodiments from about 100 to about 500 micrometers, and in some embodiments, from about 200 to about 400 micrometers. One such molded shape is a seal channel, which can retain a seal for preventing fluid leakage from the electrolyzer cell or cell stack. Another such molded shape may be a fluid channel, which can direct a fluid across a surface of the spacer frame, e.g., to or from a component retained by a spacer frame. For example, a channel can include walls that have a height of about 1000 micrometers or less, in some embodiments from about 100 to about 450 micrometers, and in some embodiments, from about 200 to about 400 micrometers. In the past, it has often been difficult to adequately fill a mold of such a small-walled channel with a polymer composition. Due to its unique properties, however, the polymer composition of the present invention is particularly well suited to form the walls of a channel. In certain embodiments, the channel can have a curved wall that defines a radius of curvature along the length of the wall in a circular or spiral fashion. A smooth curved wall can provide an improved seal in the case of a seal channel and in the case of a fluid channel a smooth, curved wall can provide an improved flow field for a fluid carried within the channel.

Various embodiments of the present invention will now be described in greater detail below.

### I. Polymer Composition

### A. Polymer Matrix

The polymer matrix typically constitutes from about 40 wt. % to 100 wt. %, in some embodiments from about 40 wt. % to about 95 wt. %, in some embodiments from about 50 wt. % to about 95 wt. %, and in some embodiments, from about 60 wt. % to about 90 wt. % of the polymer composition. In certain embodiments, the polymer composition may be unfilled such that the polymer matrix itself constitutes 100 wt. % of the composition. In other embodiments, the polymer composition may be filled such at least one filler is disposed within the polymer matrix, such as in an amount of from about 5 wt. % to about 60 wt. %, in some embodiments from about 10 wt. % to about 55 wt. %, and in some embodiments, from about 15 wt. % to about 50 wt. % of the polymer composition. Regardless of whether the composition is filled or unfilled, the polymer matrix contains at least one polyarylene sulfide. In certain embodiments, polyarylene sulfides may constitute the entire polymer matrix. In other cases, polyarylene sulfides may constitute only a portion of the matrix. In such embodiments, however, polyarylene sulfide(s) typically constitutes at least about 50 wt. % of the polymer matrix, in some embodiments at least about 65 wt. % of the polymer matrix, and in some embodiments, from about 75 wt. % to about 99 wt. % of the polymer matrix.

The polyarylene sulfide(s) employed in the polymer matrix generally have repeating units of the formula:

—[(Ar¹)ₙ—X]ₘ—[(Ar²)ᵢ—Y]ⱼ—[(Ar³)ₖ—Z]ₗ—[(Ar⁴)ₒ—W]ₚ—

wherein,
Ar¹, Ar², Ar³, and Ar⁴ are independently arylene units of 6 to 18 carbon atoms;
W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and n, m, i, j, k, I, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthalene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine, or iodine, and two halogen atoms in the same dihalo-aromatic compound may be the same or different from each other. In one embodiment, o-dichlorobenzene, m-dichlorobenzene, p-dichlorobenzene, or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

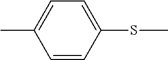

and segments having the structure of formula:

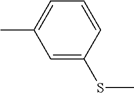

or segments having the structure of formula:

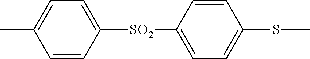

The polyarylene sulfide(s) may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any optional impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

### B. Fillers

Any of a variety of filler(s) may be disposed within the polymer matrix to further tailor the properties of the spacer frame. In one embodiment, for instance, at least one impact modifier may be disposed within the polymer matrix. When employed, such impact modifier(s) typically constitute from 5 to about 50 parts, in some embodiments from about 10 to about 45 parts, and in some embodiments, from about 20 to about 40 parts by weight per 100 parts by weight of the polyarylene sulfide(s) of the polymer matrix. For example, the impact modifiers may constitute from about 1 wt. % to about 40 wt. %, in some embodiments from about 5 wt. % to about 35 wt. %, and in some embodiments, from about 15 wt. % to about 30 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

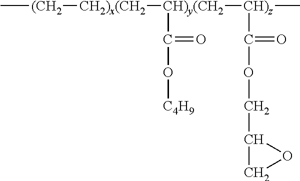

wherein, x, y, and z are 1 or greater.

The relative portion of the monomeric component(s) may be selected to achieve a balance between epoxy-reactivity and melt flow rate. More particularly, high epoxy monomer contents can result in good reactivity with the matrix polymer, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about wt. % to about 90 wt. %, and in some embodiments, from about 65 wt. % to about wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

If desired, additional impact modifiers may also be employed in combination with the epoxy-functional impact modifier. For example, the additional impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the PEBAX™ trade name. The polyamide blocks may be derived from a copolymer of a diacid component and a diamine component or may be prepared by homopolymerization of a cyclic lactam. The polyether block may be derived from homo- or copolymers of cyclic ethers such as ethylene oxide, propylene oxide, and tetrahydrofuran.

If desired, a crosslinking system may also be employed in combination with any optional impact modifier(s) to help further improve the strength and flexibility of the composition under a variety of different conditions. In such circumstances, a crosslinked product may be formed from a crosslinkable polymer matrix that contains the polyarylene sulfide(s), impact modifier(s), and crosslinking system, optionally in conjunction with one or more additional fillers. When employed, such a crosslinking system, which may contain one or more crosslinking agents, typically constitutes from about 0.1 to about 15 parts, in some embodiments from about 0.2 to about 10 parts, and in some embodiments, from about 0.5 to about 5 parts per 100 parts of the polyarylene sulfide(s) of the polymer matrix, as well as from about 0.05 wt. % to about 15 wt. %, in some embodiments from about 0.1 wt. % to about 10 wt. %, and in some embodiments, from about 0.2 wt. % to about 5 wt. % of the polymer composition. Through the use of such a crosslinking system, the compatibility and distribution of the polyarylene sulfide and impact modifier can be significantly improved. For example, the impact modifier is capable of being dispersed within the polymer composition in the form of discrete domains of a nano-scale size. For example, the domains may have an average cross-sectional dimension of from about 1 to about 1000 nanometers, in some embodiments from about 5 to about 800 nanometers, in some embodiments from about 10 to about 500 nanometers. The domains may have a variety of different shapes, such as elliptical, spherical, cylindrical, plate-like, tubular, etc. Such improved dispersion can result in either better mechanical properties or allow for equivalent mechanical properties to be achieved at lower amounts of impact modifier.

Any of a variety of different crosslinking agents may generally be employed within the crosslinking system. In one embodiment, for instance, the crosslinking system may include a metal carboxylate. Without intending to be limited by theory, it is believed that the metal atom in the carboxylate can act as a Lewis acid that accepts electrons from the oxygen atom located in a functional group (e.g., epoxy functional group) of the impact modifier. Once it reacts with the carboxylate, the functional group can become activated and can be readily attacked at either carbon atom in the three-membered ring via nucleophilic substitution, thereby resulting in crosslinking between the chains of the impact modifier. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the polymer composition.

The crosslinking system may also employ a crosslinking agent that is “multi-functional” to the extent that it contains at least two reactive, functional groups. Such a multi-functional crosslinking reagent may serve as a weak nucleophile, which can react with activated functional groups on the impact modifier (e.g., epoxy functional groups). The multi-functional nature of such molecules enables them to bridge two functional groups on the impact modifier, effectively serving as a curing agent. The multi-functional crosslinking agents generally include two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

When employed, multi-functional crosslinking agents typically constitute from about 50 wt. % to about 95 wt. %, in some embodiments from about wt. % to about 90 wt. %, and in some embodiments, from about 70 wt. % to about wt. % of the crosslinking system, while the metal carboxylates typically constitute from about 5 wt. % to about 50 wt. %, in some embodiments from about wt. % to about 40 wt. %, and in some embodiments, from about 15 wt. % to about wt. % of the crosslinking system. For example, the multi-functional crosslinking agents may constitute from about 0.1 wt. % to about 10 wt. %, in some embodiments from about 0.2 wt. % to about 5 wt. %, and in some embodiments, from about 0.5 wt. % to about 3 wt. % of the polymer composition. Of course, in certain embodiments, the composition may be generally free of multi-functional crosslinking agents, or the crosslinking system may be generally free of metal carboxylates.

Another suitable filler that may be disposed within the polymer matrix is a heat stabilizer. By way of example, the heat stabilizer can be a phosphite stabilizer, such as an organic phosphite. For example, suitable phosphite stabilizers include monophosphites and diphosphites, wherein the diphosphite has a molecular configuration that inhibits the absorption of moisture and/or has a relatively high Spiro isomer content. For instance, a diphosphite stabilizer may be selected that has a spiro isomer content of greater than 90%, such as greater than 95%, such as greater than 98%. Specific examples of such diphosphite stabilizers include, for instance, bis(2,4-dicumylphenyl)pentaerythritol diphosphite, bis(2,4-di-t-butylphenyl)pentaerythritol diphosphite, distearyl pentaerythritol diphosphite, mixtures thereof, etc. When employed, heat stabilizers typically constitute from about 0.1 wt. % to about 3 wt. %, and in some embodiments, from about 0.2 wt. % to about 2 wt. % of the composition.

Inorganic fibers may also be employed, such as in an amount from about wt. % to about 50 wt. %, in some embodiments from about 2 wt. % to about wt. %, and in some embodiments, from about 5 wt. % to about 30 wt. % of the polymer composition. Any of a variety of different types of inorganic fibers may generally be employed, such as those that are derived from glass; silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers are particularly suitable for use in the present invention, such as those formed from E-glass, A-glass, C-glass, D-glass, AR-glass, R-glass, S1-glass, S2-glass, etc., as well as mixtures thereof. If desired, the glass fibers may be provided with a sizing agent or other coating as is known in the art.

The inorganic fibers may have any desired cross-sectional shape, such as circular, flat, etc. In certain embodiments, it may be desirable to employ fibers having a relatively flat cross-sectional dimension in that they have an aspect ratio (i.e., cross-sectional width divided by cross-sectional thickness) of from about 1.5 to about 10, in some embodiments from about 2 to about 8, and in some embodiments, from about 3 to about 5. When such flat fibers are employed in a certain concentration, they may further improve the mechanical properties of the molded part without having a substantial adverse impact on the melt viscosity of the polymer composition. The inorganic fibers may, for example, have a nominal width of from about 1 to about 50 micrometers, in some embodiments from about 5 to about 50 micrometers, and in some embodiments, from about 10 to about 35 micrometers. The fibers may also have a nominal thickness of from about 0.5 to about 30 micrometers, in some embodiments from about 1 to about 20 micrometers, and in some embodiments, from about 3 to about 15 micrometers. Further, the inorganic fibers may have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. In the molded part, the volume average length of the glass fibers may be from about 10 to about 500 micrometers, in some embodiments from about 100 to about 400 micrometers, and in some embodiments, from about 150 to about 350 micrometers.

An organosilane compound may also be employed in certain embodiments. Such organosilane compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl -3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

If desired, a siloxane polymer may also be employed in the polymer composition. Without intending to be limited by theory, it is believed that the siloxane polymer can, among other things, improve the processing of the composition, such as by providing better mold filling, internal lubrication, mold release, etc. Further, it is also believed that the siloxane polymer is less likely to migrate or diffuse to the surface of the composition, which further minimizes the likelihood of phase separation and further assists in dampening impact energy. For instance, such siloxane polymers typically have a weight average molecular weight of about 100,000 grams per mole or more, in some embodiments about 200,000 grams per mole or more, and in some embodiments, from about 500,000 grams per mole to about 2,000,000 grams per mole. The siloxane polymer may also have a relatively high kinematic viscosity, such as about 10,000 centistokes or more, in some embodiments about 30,000 centistokes or more, and in some embodiments, from about 50,000 to about 500,000 centistokes.

Any of a variety of high molecular weight siloxane polymers may generally be employed in the polymer composition. In certain embodiments, for example, the siloxane polymer may be an “MQ” resin, which is a macromolecular polymer formed primarily from R₃SiO_{1/2} and SiO_{4/2} units (the M and Q units, respectively), wherein R is a functional or nonfunctional organic group. Suitable organofunctional groups (“R”) may include, for instance, alkyl (e.g., methyl, ethyl, propyl, butyl, etc.), aryl (e.g., phenyl), cycloalkyl (e.g., cyclopentyl), arylenyl, alkenyl, cycloalkenyl (e.g., cyclohexenyl), alkoxy (e.g., methoxy), etc., as well as combinations thereof. Such resins are generally prepared by chemically linking (copolymerizing) MQ resin molecules having a low weight average molecular weight (such as less than 100,000 grams per mole) with polysiloxane linkers. In one particular embodiment, for instance, the resin may be formed by copolymerizing a low molecular weight MQ solid resin (A) with a substantially linear polydiorganosiloxane linker (B), such as described in U.S. Pat. No. 6,072,012 to Juen, et al. The resin (A) may, for instance, have M and Q siloxy units having the following general formula:

R¹ₐR²_{b}R³_{c}SiO_{4-a-b-c)/2}

wherein,
R¹ is a hydroxyl group;
R² is a monovalent hydrocarbon group having at least one unsaturated carbon-carbon bond (i.e., vinyl) that is capable of addition reaction with a silicon-bonded hydrogen atom;
each R³ is independently selected from the group consisting of alkyl, aryl and arylalkyl groups;
a is a number from 0 to 1, and in some embodiments, from 0 to 0.2;
b is number from 0 to 3, and in some embodiments, from 0 to 1.5; and
c is a number greater than or equal to 0.

The substantially linear polydiorganosiloxane linker (B) may likewise have the following general formula:

(R⁴₍₃₋ₚ₎R⁵ₚSiO_{1/2})(R⁴₂SiO_{2/2})ₓ((R⁴R⁵SiO_{2/2})(R⁴₂SiO_{2/2})ₓ)_{y}(R⁴₍₃₋ₚ₎R⁵ₚSiO_{1/2})

wherein,
each R⁴ is a monovalent group independently selected from the group consisting of alkyl, aryl, and arylalkyl groups;
each R⁵ is a monovalent group independently selected from the group consisting of hydrogen, hydroxyl, alkoxy, oximo, alkyloximo, and aryloximo groups, wherein at least two R⁵ groups are typically present in each molecule and bonded to different silicon atoms;
p is 0, 1, 2, or 3;
x ranges from 0 to 200, and in some embodiments, from 0 to 100; and
y ranges from 0 to 200, and in some embodiments, from 0 to 100.

The high molecular siloxane polymers typically constitute from about 0.05 wt. % to about 5 wt. %, in some embodiments from about 0.1 wt. % to about 3 wt. %, and in some embodiments, from about 0.5 to about 2 wt. % of the polymer composition.

In certain embodiments, the siloxane polymer may be provided in the form of a masterbatch that includes a carrier resin. The carrier resin may, for instance, constitute from about 0.05 wt. % to about 5 wt. %, in some embodiments from about 0.1 wt. % to about 3 wt. %, and in some embodiments, from about 0.5 to about 2 wt. % of the polymer composition. Any of a variety of carrier resins may be employed, such as polyolefins (ethylene polymer, propylene polymers, etc.), polyamides, etc. In one embodiment, for example, the carrier resin is an ethylene polymer. The ethylene polymer may be a copolymer of ethylene and an α-olefin, such as a C₃-C₂₀ α-olefin or C₃-C₁₂ α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl, or propyl substituents; 1-hexene with one or more methyl, ethyl, or propyl substituents; 1-heptene with one or more methyl, ethyl, or propyl substituents; 1-octene with one or more methyl, ethyl, or propyl substituents; 1-nonene with one or more methyl, ethyl, or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole%. The α-olefin content may likewise range from about 1 mole % to about 40 mole %, in some embodiments from about 1.5 mole % to about 15 mole %, and in some embodiments, from about 2.5 mole % to about 13 mole %. The density of the ethylene polymer may vary depending on the type of polymer employed, but generally ranges from about 0.85 to about 0.96 grams per cubic centimeter (g/cm³). Polyethylene “plastomers”, for instance, may have a density in the range of from about 0.85 to about 0.91 g/cm³. Likewise, “linear low density polyethylene” (LLDPE) may have a density in the range of from about 0.91 to about 0.940 g/cm³; “low density polyethylene” (LDPE) may have a density in the range of from about to about 0.940 g/cm³; and “high density polyethylene” (HDPE) may have density in the range of from about 0.940 to about 0.960 g/cm³, such as determined in accordance with ASTM D792. Some non-limiting examples of high molecular weight siloxane polymer masterbatches that may be employed include, for instance, those available from Dow Corning under the trade designations MB50-001, MB50-002, MB50-313, MB50-314 and MB50-321.

If desired, a nucleating agent may also be employed to further enhance the crystallization properties of the composition. One example of such a nucleating agent is an inorganic crystalline compound, such as boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), and so forth. Boron nitride (BN) has been found to be particularly beneficial when employed in the polymer composition of the present invention. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form is particularly suitable due to its stability and softness.

Still other components that can be included in the composition may include, for instance, particulate fillers (e.g., talc, mica, etc.), antimicrobials, pigments (e.g., black pigments), antioxidants, stabilizers, surfactants, waxes, flow promoters, solid solvents, flame retardants, and other materials added to enhance properties and processability.

### II. Melt Processing

The manner in which the polyarylene sulfide(s) and any optional fillers are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. A variety of different techniques may be employed in the present invention to react the polyarylene sulfide and impact modifier in the presence of the crosslinking system. Likewise, the apparent shear rate during melt processing may range from about 100 seconds⁻1 to about 10,000 seconds⁻1, and in some embodiments, from about 500 seconds⁻1 to about 1,500 seconds⁻1. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The melting temperature of the polymer composition may also range from about 250° C. to about 320° C., and in some embodiments, from about 260° C. to about 300° C. The melting and crystallization temperatures may be determined as is well known in the art using differential scanning calorimetry in accordance with ISO Test No. 11357-3:2018.

### III. Spacer Frame

The polymer composition may be shaped into the form of a spacer frame using any of a variety of techniques as is known in the art. In certain embodiments, for instance, a shaped part may be formed by a molding technique, such as injection molding, compression molding, nanomolding, overmolding, blow molding, thermoforming, etc.; melt extrusion techniques, such as tubular trapped bubble film processes, flat or tube cast film processes, slit die flat cast film processes, etc.; and so forth.

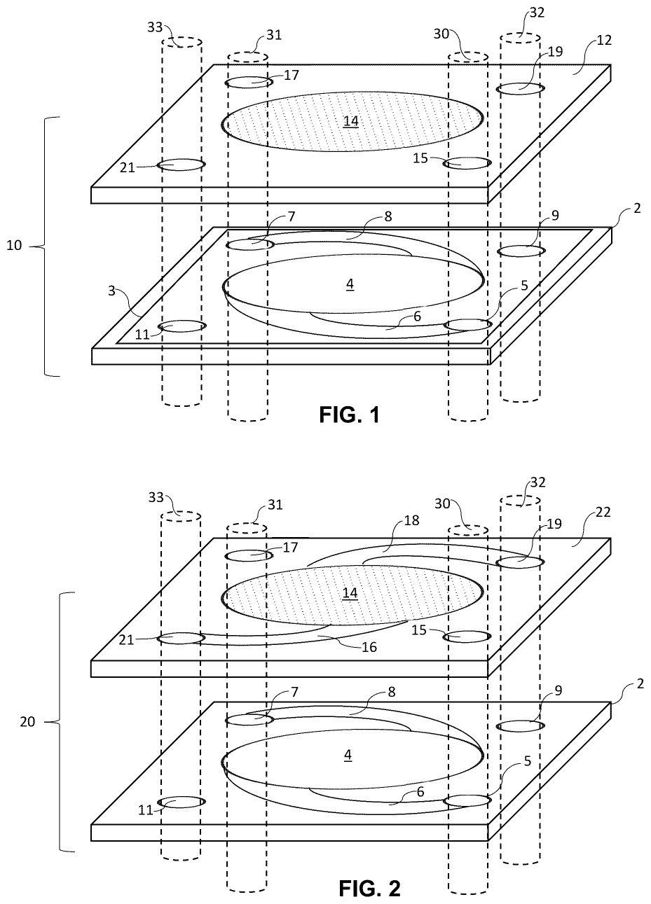

FIG. 1 illustrates one embodiment of a bipolar electrode alkaline electrolyzer cell 10 that can include alkaline electrolyzer spacer frames 2, 12 one or both of which can be formed of the polymer composition. In the illustrated embodiment, a first alkaline electrolyzer spacer frame 2 can hold a bipolar electrode 4. As illustrated, the alkaline electrolyzer spacer frame 2 can define a flow channel 6 that extends between an inlet 5 through which a fluid may enter the cathode side of the cell 10 and be directed to the cathodic side of the bipolar electrode 4 and a flow channel 8 and an outlet 7 through which the fluid may exit from the cathode side of the cell 10. The inlet 9 and outlet 11 can be associated with similar channels (not shown in FIG. 1) that can direct a fluid toward and away from the anodic side of the bipolar electrode 4, which is opposite to the illustrated cathodic side.

The spacer frame 2 (as well as any other spacer described herein) can also define a seal channel 3 in the surface that can retain a seal to prevent fluid leakage from the assembled cell 10. It will be understood that while illustrated with a generally square plate shape, spacer frames 2, 12 can have any suitable peripheral shape, e.g., round, oval, rectangular, etc. Likewise, an electrolyzer cell component retained by a spacer frame can have any desired peripheral shape, e.g., round as shown as well as any other desired shape.

The bipolar electrode alkaline electrolyzer cell 10 can also include a second spacer frame 12 that surrounds and retains at least one separator 14 that may create a physical barrier between the anode and cathode and yet allow the passage of ions (e.g., hydroxide anions) created at one side of a bipolar electrode 4 to the associated side of an adjacent bipolar electrode (not shown in FIG. 1). The separator 14 may have a variety of different forms as is known in the art. In one embodiment, for example, a “macroporous” separator may be employed, such as a fibrous mesh or web having a pore size on the order of millimeters or centimeters (e.g., about 0.1 to about 50 millimeters). The separator 14 may also include a “microporous” separator, also known as a diaphragm. Such separators generally have a pore size on the order of micrometers, e.g., from about 0.1 micrometers to about 100 micrometers, or from about 1 micrometer to about 50 micrometers in some embodiments. Typical microporous separators may include, for instance, microporous ceramics, microporous polymeric films (e.g., porous polyvinyl chloride (PVC), polyolefins, and PTFE). The separator 14 may also include an anion exchange membrane to prevent convection and diffusion, while permitting anion movement across the membrane. One example of such a membrane is a polymer electrolyte membrane that allows passage of anions (e.g., hydroxide anions) created at one side of a bipolar electrode 4 to the associated side of an adjacent bipolar electrode (not shown in FIG. 1). Such an anion exchange membrane may include, for instance, a composite of zirconia and polysulfone available under the trade designation Zirfon®. Combinations of macroporous separators, microporous separators, and/or anion exchange members may also be employed in the separator 14.

The second spacer frame 12 can define an inlet 15 that aligns with inlet 5 during assembly of cell 10 to form a cathode feed 30 for carrying a cathode feed fluid through the assembled cell 10. Outlet 17 aligns with outlet 7 during assembly of cell 10 to form a cathode outlet 31 for carrying a cathode product fluid through the assembled cell 10. Inlet 19 aligns with inlet 9 during assembly of cell 10 to form an anode inlet 32 for carrying an anode feed fluid through the cell 10. Outlet 21 aligns with outlet 11 during assembly of cell 10 to form an anode outlet 33 for carrying an anode product fluid through the cell 10.

Not all of the spacer frames of a cell need define a flow channel therein. For instance, the alkaline electrolyzer cell 10 of FIG. 1 includes a spacer frame 12 for a separator 14 that does not define flow channels therein. However, in other embodiments, adjacent spacer frames can define flow channels therein that can align with one another during assembly. FIG. 2 illustrates a bipolar electrode alkaline electrolyzer cell 20 that includes a spacer frame 2 for a bipolar electrode 4, as in the cell 10 of FIG. 1. The spacer frame 22 of electrolyzer cell retains a separator 14 and inlets and outlets 15, 17, 19, 21, as described above. Spacer frame 22 also defines flow channels 16, 18 in the surface of the spacer frame 22. Upon assembly of the cell 20, flow channels 16, 18 will align with anodic fluid inlet and outlet channels of an adjacent spacer frame (not shown in FIG. 2) that retains a bipolar electrode. The spacer frame 22 can also include flow channels on the lower side of the spacer frame 22 (not visible in FIG. 2) that can align with cathodic inlet and outlet channels 6, 8.

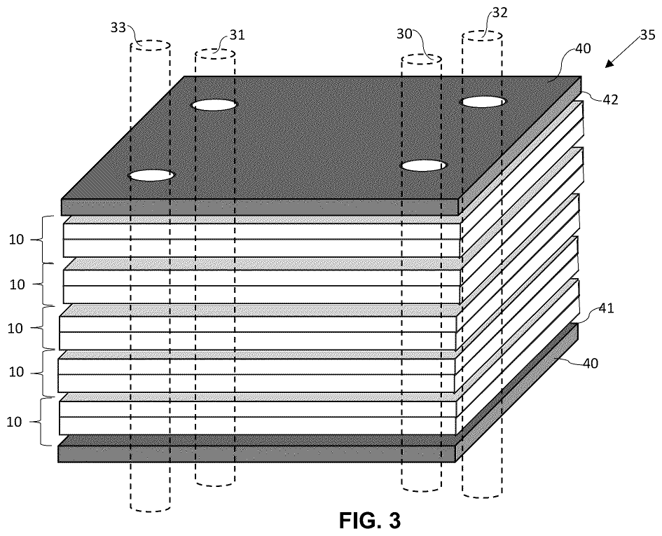

In general, the alkaline electrolyzer system will include one or more stacks, each of which includes multiple alkaline electrolyzer cells in fluid and electronic communication with one other. FIG. 3 illustrates one representative stack 35 that includes five (5) alkaline electrolyzer cells 10 aligned with one another. The individual alkaline electrolyzer cells 10 can be joined to one another, for instance by adhesion, welding, bolting, etc. or by use of a case or shell that holds the individual components of the stack together with pressure seals. A stack 35 can include additional spacers, in addition to the spacer frames 2, 12 of each cell 10 (FIG. 1). For instance, a stack 35 can include one or more terminal alkaline electrolyzer spacer plates 40. In embodiments, a spacer plate can be associated with a current collector 41, 42 at either end of the cell. For example, a current collector 41, 42 can be adhered to a surface of the spacer plate 40 and in electrical communication with the multiple cells 10 and an external circuit. Of course, a stack 35 can include any number of individual electrolyzer cells, e.g., hundreds of cells in some embodiments.

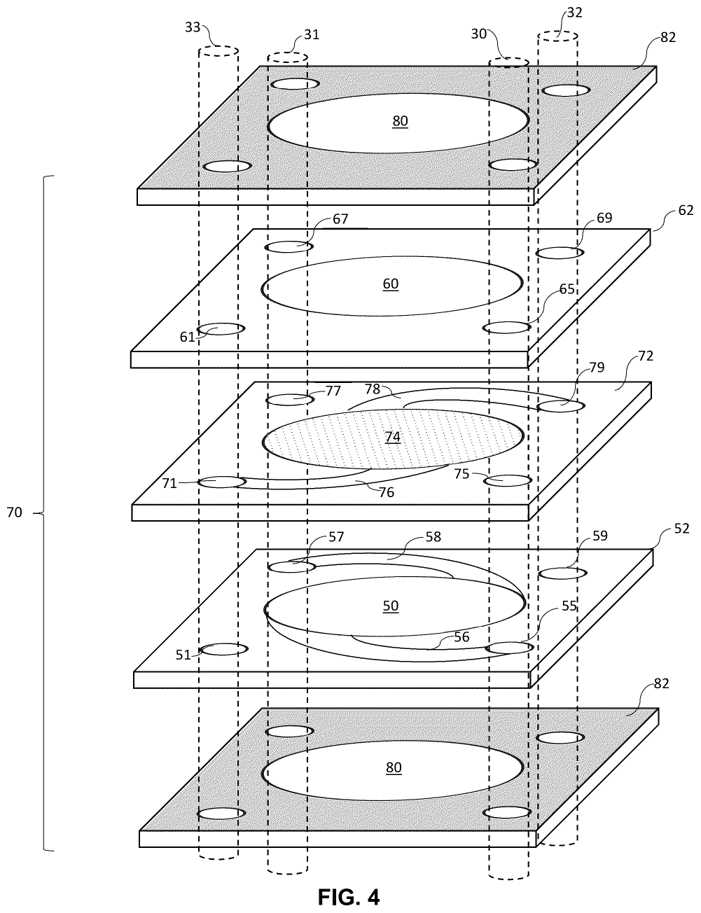

An alkaline electrolyzer cell that includes one or more spacer frames is not limited to a bipolar electrode electrolyzer cell, and an electrolyzer cell can include monopolar electrodes as well as other cell components as are generally known in the art, one or more of which can include a spacer frame of the polymer composition. For instance, FIG. 4 illustrates a unipole electrode alkaline electrolyzer cell 70 that includes a cathode 50 and an anode 60 separated by a separator 74. As indicated, the cathode 50 can be retained by a spacer frame 52 that surrounds the cathode 50. The spacer frame 52 can define cathode and anode feed inlets 55, 59, respectively and cathode and anode product outlets 57, 51, respectively as described previously. The surface of the spacer frame 52 can also define flow channels 56, 58 for delivering a cathode flow to and from the cathode 50. The anode 60 can be retained by a spacer frame 62 and can define cathode and anode feed inlets 65, 69 respectively and cathode and anode product outlets 67, 61, respectively. The unseen underside surface of the spacer frame 62 can also define flow channels for delivering an anode flow to and from the anode 60. The spacer frame 72 can retain the separator 74 therein and can define flow channels 76, 78 that can align with the unseen flow channels on the underside of the spacer frame 62 to encourage flow to and from the anode 60. Likewise, flow channels 56, 58 of the spacer frame 52 can align with flow channels on the underside of the spacer frame 72 to encourage flow to and from the cathode 50. The alkaline electrolyzer cell 70 also includes a spacer frame 82 at either end of the cell 70, each of which retains a bipolar plate 80. The bipolar plate 80 can be a plate of any peripheral shape (e.g., circular as shown) that can provide electric conductivity between adjacent cells of a cell stack and that is generally formed of a metal, e.g., titanium or stainless steel.

Additional alkaline electrolyzer spacer frames or spacer plates as known in the art and that include a polymer composition as described can be incorporated in a cell. For instance, in some embodiments, an electrolyzer cell can include a gas diffusion layer, which is generally located between a bipolar plate and an electrode. A gas diffusion layer can be retained by an alkaline electrolyzer spacer frame as described herein. Of course, the alkaline electrolyzer cell can also include spacer frames and spacer plates made from materials other than the polymer composition of the present invention if so desired.

### IV. Electrolyzer System

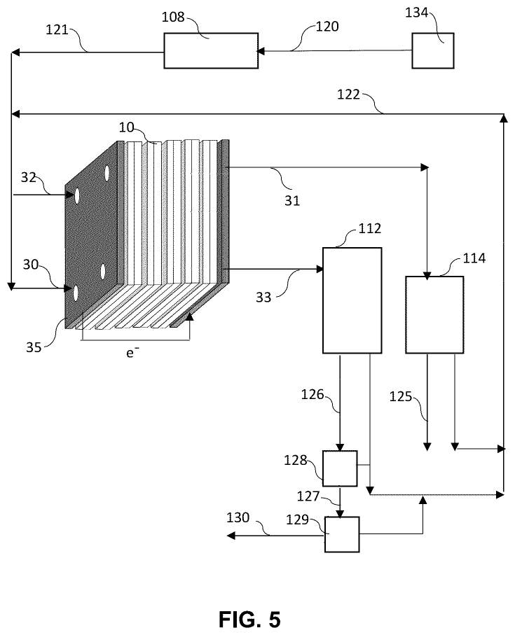

The alkaline electrolyzer spacer frame may be employed in an anion exchange alkaline electrolyzer system. Referring to FIG. 5, for instance, one embodiment of an alkaline electrolyzer system is illustrated that contains an alkaline electrolyzer stack 35 that incorporates a plurality of bipolar electrode electrolyzer cells 10 as described above. Of course, any alkaline electrolyzer cell or stack thereof that includes a spacer frame that in turn includes the polymer composition could be incorporated in an alkaline electrolyzer system. In the illustrated embodiment, feed can be supplied to both sides of the electrolyzer cell stack 35 via a cathode inlet 30 to the cathode side of the cell and an anode inlet 32 to the anode side of the cell. In some embodiments, feed may be fed only one side of the cells of the stack 35. In those embodiments in which the cells include an anion exchange membrane separator, feed may be fed to both sides of the cell in order to maintain hydration of the membrane. Product outlets 31, 33, can deliver the electrolysis products (e.g., oxygen and hydrogen) from the cell stack 35. The feed can be an alkaline aqueous solution, e.g., an aqueous solution of a suitable alkaline, including without limitation, potassium hydroxide, sodium hydroxide, lithium hydroxide, or mixtures thereof. For instance, the feed can include from about 20 wt. % to about 40 wt. % alkaline in an aqueous solution.

Feed can be provided to inlets 30, 32 via a common feed line 121 as well as a recycle hose 122. In embodiments, feed to the cell can be pretreated, such as by initial feed 120 to a heat exchanger 108 to heat the feed to a suitable temperature (e.g., about 80° C.). Outlets 31, 33 can carry the oxygen and hydrogen products to additional system components such as product separators 112, 114, demisters 128 and dryers 129. Separated hydrogen and oxygen product of the cell stack 35 can be delivered from the system 125, 130. For instance, hydrogen product can be delivered directly to a system for utilization, e.g., to a fuel cell as a fuel, to a storage facility, or to a secondary system for further processing, e.g., chemical formation.

To operate the alkaline electrolyzer cell stack 35, a water pump 134 is operated to introduce feed 120 into any preprocessing procedures, e.g., heating via heat exchanger 108, and then into one or both sides of the electrochemical cell stack via inlets 32, 33. In some embodiments, the feed can be fed to both sides of the cell stack 35 in order to provide the cell components (e.g., anion exchange membranes) with moisture high enough to allow the performance of the cell stack 35.

At the cathode (or cathode side of a bipolar electrode) of an anion exchange electrolyzer, water is reacted according to the half reaction:

2H₂O+2e⁻→H₂+2OH⁻

The hydroxide ions thus formed at the cathode are transported to the anode, where reaction occurs according to the half reaction:

2OH⁻→½O₂+H₂O+2e⁻

The oxygen and hydrogen are then discharged from the cell stack via outlets 31, 33. In general, the products can be discharged with feed so far as feed has been supplied in an amount great enough to purge products from the cell stack 35. Thereafter, the oxygen and hydrogen products can be separated from the remaining feed, e.g., via product separators 112, 114, demister 128, dryer 129, to provide purified hydrogen product 130 and oxygen product 125. The separated feed can be recycled to the cell stack 35 via recycle hose 122.

The following test methods may be employed to determine one or more of the parameters described herein.

### Test Methods

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Melting Temperature: The melting temperature (“Tm”) may be determined by differential scanning calorimetry (“DSC”) as is known in the art. For semi-crystalline and crystalline materials, the melting temperature is the differential scanning calorimetry (DSC) peak melt temperature as determined by ISO 11357:2018. Under the DSC procedure, samples were heated and cooled at 10° C. per minute using DSC measurements conducted on a TA Q2000 Instrument.

Tensile Modulus, Tensile Stress at Break, and Tensile Strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO Test No. 178:2019 (technically equivalent to ASTM D790-17). This test may be performed on a 64 mm support span. Tests may be run on the center portions of uncut ISO 3167 multi-purpose bars. The testing temperature may be 23° C. and the testing speed may be 1 or 5 mm/min.

Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C. or −30° C.

Chlorine Content: Chlorine content may be determined according to an elemental analysis analysis using Parr Bomb combustion followed by Ion Chromatography.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. An alkaline electrolyzer system comprising an electrochemical cell in proximity to a spacer frame, wherein the spacer frame contains a polymer composition that includes from about 40 wt. % to about 95 wt. % of a polymer matrix that contains at least one polyarylene sulfide and from about 5 wt. % to about 60 wt. % of at least one filler disposed within the polymer matrix.

2. The alkaline electrolyzer system of claim 1, wherein the filler includes an impact modifier.

3. The alkaline electrolyzer system of claim 2, wherein the impact modifier includes an epoxy-functionalized olefin copolymer.

4. The alkaline electrolyzer system of claim 3, wherein the epoxy-functionalized olefin copolymer contains an ethylene monomeric unit.

5. The alkaline electrolyzer system of claim 3, wherein the epoxy-functionalized olefin copolymer contains an epoxy-functional (meth)acrylic monomeric component.

6. The alkaline electrolyzer system of claim 2, wherein the polymer composition contains a crosslinked product formed by blending the impact modifier with a crosslinking system.

7. The alkaline electrolyzer system of claim 6, wherein the crosslinking system includes a metal carboxylate.

8. The alkaline electrolyzer system of claim 6, wherein the crosslinking system includes an aromatic dicarboxylic acid.

9. The alkaline electrolyzer system of claim 1, wherein the spacer frame includes a curved wall defining a channel, wherein the curved wall contains the polymer composition.

10. The alkaline electrolyzer system of claim 9, wherein the channel is a seal channel.

11. The alkaline electrolyzer system of claim 9, wherein the channel is a flow channel.

12. The alkaline electrolyzer system of claim 11, wherein the flow channel extends from an inlet or outlet defined in the spacer frame to a component of the electrochemical cell, wherein the spacer frame surrounds the component.

13. The alkaline electrolyzer system of claim 9, wherein the curved wall has a height of about 1,000 micrometers or less.

14. The alkaline electrolyzer system of claim 9, wherein the curved wall defines a circular or spiral radius of curvature.

15. An alkaline electrolyzer system comprising an electrochemical cell in proximity to a spacer frame that includes a curved wall defining a channel, wherein the curved wall contains a polymer composition that includes a polymer matrix that contains at least one polyarylene sulfide.

16. The alkaline electrolyzer system of claim 15, wherein the spacer frame includes a curved wall defining a channel, wherein the curved wall contains the polymer composition.

17. The alkaline electrolyzer system of claim 16, wherein the channel is a seal channel.

18. The alkaline electrolyzer system of claim 16, wherein the channel is a flow channel.

19. The alkaline electrolyzer system of claim 18, wherein the flow channel extends from an inlet or outlet defined in the spacer frame to a component of the electrochemical cell, wherein the spacer frame surrounds the component.

20. The alkaline electrolyzer system of claim 15, wherein the curved wall has a height of about 1,000 micrometers or less.

21. The alkaline electrolyzer system of claim 15, wherein the curved wall defines a circular or spiral radius of curvature.

22. The alkaline electrolyzer system of claim 1, wherein the polymer composition has a melt viscosity of about 2,000 Pa-s or less as determined in accordance with ISO 1143:2021 at a temperature of about 310° C. and a shear rate of 1,200 seconds⁻¹.

23. The alkaline electrolyzer system of claim 1, wherein the polymer composition has a chlorine content of about 1,200 ppm or less.

24. The alkaline electrolyzer system of claim 1, wherein the polymer composition exhibits a notched Charpy impact strength of about 20 kJ/m² or more as determined at a temperature of 23° C. in accordance with ISO Test No. 179-1:2010.

25. The alkaline electrolyzer system of claim 1, wherein the polymer composition exhibits a notched Charpy impact strength of about 10 kJ/m² or more as determined at a temperature of −30° C. in accordance with ISO Test No. 179-1:2010.

26. The alkaline electrolyzer system of claim 1, wherein the polymer composition exhibits a tensile strength of about 20 MPa or more; a tensile break strain of about 20% or more; and/or a tensile modulus of about 10,000 MPa or less, as determined in accordance with ISO 527:2019 at a temperature of 23° C.

27. The alkaline electrolyzer system of claim 1, wherein the polymer composition exhibits a flexural strength of about 20 MPa or more and/or a flexural modulus of about 10,000 MPa or less as determined in accordance with ISO 178:2019 at a temperature of 23° C.

28. The alkaline electrolyzer system of claim 1, wherein the polyarylene sulfide includes a polyphenylene sulfide.

29. The alkaline electrolyzer system of claim 1, wherein the electrochemical cell contains a separator positioned between electrodes.

30. The alkaline electrolyzer system of claim 1, wherein the spacer frame surrounds a component of the electrochemical cell.

31. The alkaline electrolyzer system of claim 30, wherein the component of the electrochemical cell includes an electrode.

32. The alkaline electrolyzer system of claim 30, wherein the component of the electrochemical cell includes a separator.

33. The alkaline electrolyzer system of claim 30, wherein the separator includes an anion exchange member.

34. The alkaline electrolyzer system of claim 30, wherein the component of the electrochemical cell includes a bipolar plate.

35. The alkaline electrolyzer system of claim 1, wherein the spacer frame is adjacent to an end of a cell stack that contains the electrochemical cell.

36. The alkaline electrolyzer system of claim 35, wherein the spacer frame is adjacent to a current collector.
